(19) United States
(12) Patent Application Publication
(10) Pub. No.: US 2026/0342902 A1
(43) Pub. Date: Oct. 29, 2026

(54) MOBILE PHONE STAND

(71) Applicant: Dongbo Yang, Shaoyang City (CN)

(72) Inventor: Dongbo Yang, Shaoyang City (CN)

(21) Appl. No.: 19/386,430

(22) Filed: Nov. 12, 2025

(30) Foreign Application Priority Data
Apr. 29, 2025 (CN) 202520847554.9

(51) Int. Cl. H04M 1/04; F16M 11/04; F16M 11/10; F16M 11/20; F16M 13/02

(52) U.S. Cl. CPC H04M 1/04; F16M 11/041; F16M 11/10; F16M 11/2057; F16M 13/02

(57) ABSTRACT

A mobile phone stand is provided to solve the technical problem in the prior art that the mobile phone stand is large in structure and inconvenient to carry. The apparatus includes a connecting disk component, a rotational connecting component, a hinge rod portion, and a supporting disk portion, where a connecting portion configured to connect a mobile phone is disposed on the connecting disk component, one end of the connecting disk component is provided with a mounting groove, the rotational connecting component is rotatably disposed in the mounting groove, one end of the hinge rod portion is hinged to the rotational connecting component, and the other end of the hinge rod portion is hinged to the supporting disk portion. The supporting disk portion is able to be folded and be close to the connecting disk component, and the supporting disk portion is at least partially located in the mounting groove.

### CROSS-REFERENCE TO RELATED APPLICATION

This patent application claims the benefit and priority of Chinese Patent Application No. 202520847554.9 filed with the China National Intellectual Property Administration on Apr. 29, 2025, the disclosure of which is incorporated by reference herein in its entirety as part of the present application.

### TECHNICAL FIELD

The present disclosure relates to the technical field of mobile phone accessories, in particular to a mobile phone stand.

### BACKGROUND

Mobile phone stands are external mobile phone accessories configured to support mobile phones to liberate both hands. Currently, the common mobile phone stand on the market includes a base, a rotary joint, a hinge rod, and a connecting seat. This type of stand can effectively implement support and angle adjustment on a mobile phone, but the stand is relatively large in structure and inconvenient to carry, so that the stand is still inconvenient when the mobile phone is used outdoors.

### SUMMARY

An objective of the present disclosure is to provide a mobile phone stand, so as to solve the technical problem in the prior art that the mobile phone stand is large in structure and inconvenient to carry. Various technical effects generated by a preferred technical solution in various technical solutions provided by the present disclosure are explained in detail as follow.

In order to achieve the foregoing objective, the present disclosure provides the following technical solution.

A mobile phone stand is provided by present disclosure, comprising a connecting disk component, a rotational connecting component, a hinge rod portion, and a supporting disk portion, wherein a connecting portion configured to connect a mobile phone is disposed on the connecting disk component, one end of the connecting disk component is provided with a mounting groove, the rotational connecting component is rotatably disposed in the mounting groove, one end of the hinge rod portion is hinged to the rotational connecting component, and the other end of the hinge rod portion is hinged to the supporting disk portion; the supporting disk portion is able to be folded and be close to the connecting disk component, and the supporting disk portion is at least partially located in the mounting groove;

the connecting disk component comprises an outer ring seat, a connecting portion, and a base plate, a middle part of the outer ring seat and the base plate form the mounting groove, one end that is of the outer ring seat and that faces the base plate is provided with a setting groove, the connecting portion is disposed in the setting groove, and the outer ring seat is connected to the base plate; and

the rotational connecting component comprises a gear rotating disk and an elastic limiting component, one end that is of the outer ring seat and that faces the base plate is provided with an annular groove and a limiting groove, the annular groove is located on a peripheral side of the mounting groove, the limiting groove is located on one side that is of the annular groove and that is away from the mounting groove, the limiting groove is in communication with the annular groove, the gear rotating disk is disposed in the annular groove, the elastic limiting component is disposed in the limiting groove, one end of the elastic limiting component abuts against an inner wall of the limiting groove, and the other end of the elastic limiting component abuts against an outer peripheral gear surface of the gear rotating disk.

Preferably, the setting groove is located on a peripheral side of the mounting groove, and the connecting portion is a magnet.

Preferably, a middle part of the gear rotating disk is provided with a first mounting hole, a first end of the hinge rod portion is hinged to an inner wall of the first mounting hole, the other end of the hinge rod portion is hinged to the supporting disk portion, and the hinge rod portion is able to be folded into the first mounting hole.

Preferably, the supporting disk portion comprises a disk housing and a connecting plate, one end that is of the disk housing and that faces the connecting disk component is provided with an accommodation tank, the connecting plate is disposed in the accommodation tank, a middle part of the connecting plate is provided with a second mounting hole, and the hinge rod portion is hinged to an inner wall of the second mounting hole.

Preferably, one end that is of the disk housing and that is away from a hinge position of the hinge rod portion and the supporting disk portion is provided with a supporting protrusion, and the supporting protrusion is planar.

Preferably, an outer sleeve is disposed outside the hinge rod portion, and the outer sleeve is made of a skin-friendly material.

Preferably, the elastic limiting component comprises a limiting member and a resetting member, one end of the limiting member abuts against an outer peripheral gear surface of the gear rotating disk, and the other end of the limiting member is connected to the limiting groove by using the resetting member.

Preferably, the elastic limiting component is a spring needle.

By adopting the foregoing technical solution, the present disclosure has the following beneficial effects.

The mobile phone stand includes a connecting disk component, a rotational connecting component, a hinge rod portion, and a supporting disk portion. A connecting portion configured to connect a mobile phone is disposed on the connecting disk component, so that the mobile phone stand may be connected to the mobile phone and is convenient to carry. One end of the connecting disk component is provided with a mounting groove. The rotational connecting component is rotatably disposed in the mounting groove. One end of the hinge rod portion is hinged to the rotational connecting component, and the other end of the hinge rod portion is hinged to the supporting disk portion The supporting disk portion can be folded and be close to the connecting disk component, and the supporting disk portion is at least partially located in the mounting groove. Therefore, in a folded state, the supporting disk portion is close to the connecting disk component and is located in the mounting groove, so that the mobile phone stand is relatively flat and relatively small in volume in the folded state, and the mobile phone stand is convenient to carry.

The rotational connecting component includes a gear rotating disk and an elastic limiting component. By setting the elastic limiting component and the gear rotating disk, the supporting disk portion may be unfolded after rotating to a specified direction by using the rotational connecting component, so as to achieve a good supporting effect. In this way, positioning support can be implemented at any angle.

It should be understood that the above general description and later detail description are just exemplary and explanatory, but cannot restrict the disclosure.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Clearly, the accompanying drawings in the following description show merely some embodiments of the present disclosure, and a person of ordinary skill in the art may derive other drawings from these accompanying drawings without creative efforts.

FIG. 1 is a structural schematic diagram of a mobile phone stand according to an embodiment of the present disclosure;

FIG. 2 is a schematic diagram of an unfolded structure of a mobile phone stand according to an embodiment of the present disclosure;

FIG. 3 is a schematic diagram of a folded structure of a mobile phone stand according to an embodiment of the present disclosure;

FIG. 4 is a schematic diagram of a sectional structure of FIG. 3;

FIG. 5 is a schematic diagram of an exploded structure of a mobile phone stand according to an embodiment of the present disclosure; and

FIG. 6 is a schematic diagram of a mobile phone stand with the hinge rod portion detached.

Reference numerals: 1: connecting disk component; 2: rotational connecting component; 3: hinge rod portion; 4: supporting disk portion; 5: connecting portion; 6: mounting groove; 7: outer ring seat; 8: base plate; 9: gear rotating disk; 10: elastic limiting component; 11: annular groove; 12: limiting groove; 13: first mounting hole; 14: disk housing; 15: connecting plate; 16: supporting protrusion; 17: outer sleeve; 18: open spring plate; 19: elastic limiting component cover plate; 20: cover sheet; 21: decorative sheet; 22: limiting member; and 23: resetting member.

### DETAILED DESCRIPTION OF THE EMBODIMENTS

In order to make the purpose, technical solutions and advantages of the present disclosure more clear, the technical solutions of the present disclosure are described in detail as follows. Apparently, the embodiments in the following description are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

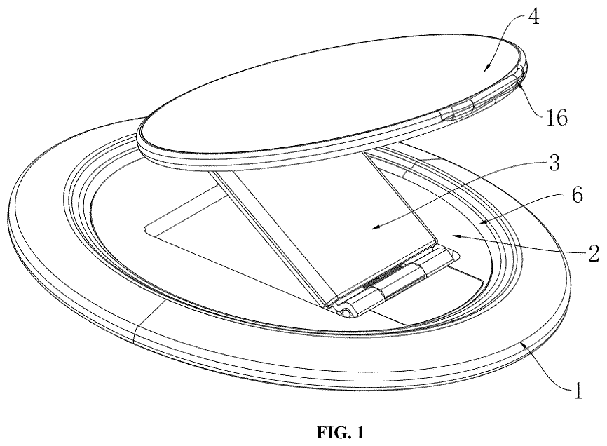

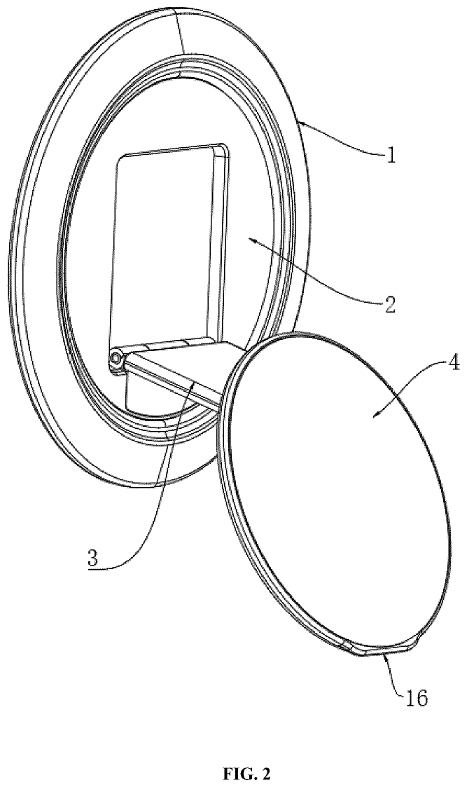

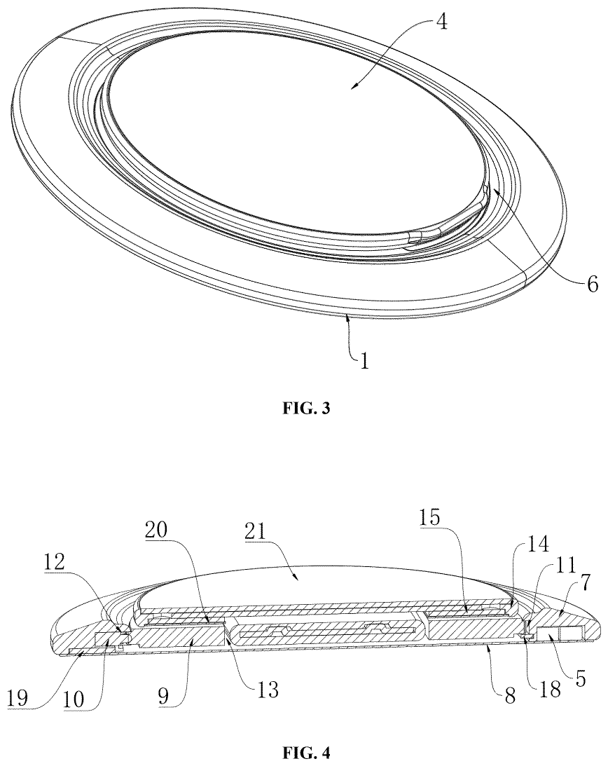

A specific embodiment of the present disclosure provides a mobile phone stand. As shown in FIG. 1 to FIG. 3, the mobile phone stand mainly includes a connecting disk component 1, a rotational connecting component 2, a hinge rod portion 3, and a supporting disk portion 4, where a connecting portion 5 configured to connect a mobile phone is disposed on the connecting disk component 1. Connection with the mobile phone can be implemented by using the connecting portion 5. In this way, the mobile phone stand is connected to the mobile phone so as to be convenient to carry. One end of the connecting disk component 1 is provided with a mounting groove 6. The rotational connecting component 2 is rotatably disposed in the mounting groove 6. One end of the hinge rod portion 3 is hinged to the rotational connecting component 2, and the other end of the hinge rod portion 3 is hinged to the supporting disk portion 4. In this way, angle adjustment can be carried out on the supporting disk portion 4 based on user needs by setting the rotational connecting component 2. Angle adjustment of the supporting disk portion 4 is implemented by using the hinge rod portion 3. The supporting disk portion 4 can be folded and be close to the connecting disk component 1, so that the mobile phone stand is relatively flat. Moreover, the supporting disk portion 4 is at least partially located in the mounting groove 6. In this way, the mobile phone stand is flat as much as possible, so that the volume of the mobile phone stand in the folded state is as small as possible, and the mobile phone stand is more convenient to carry.

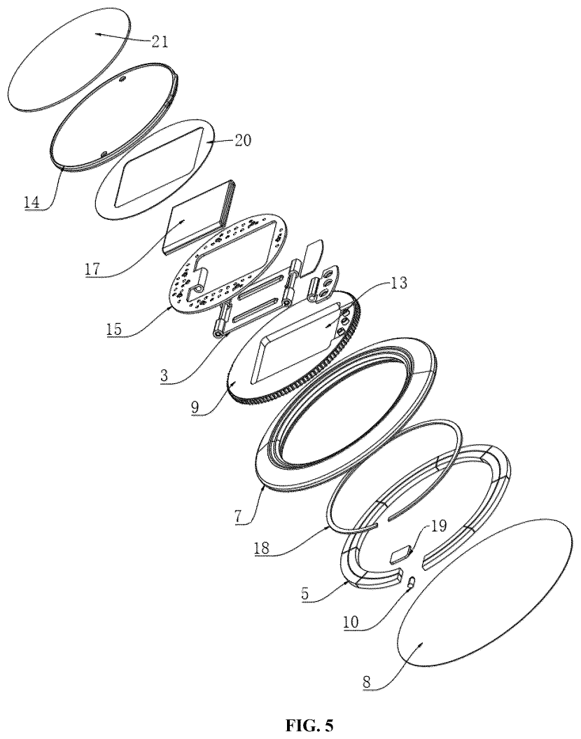

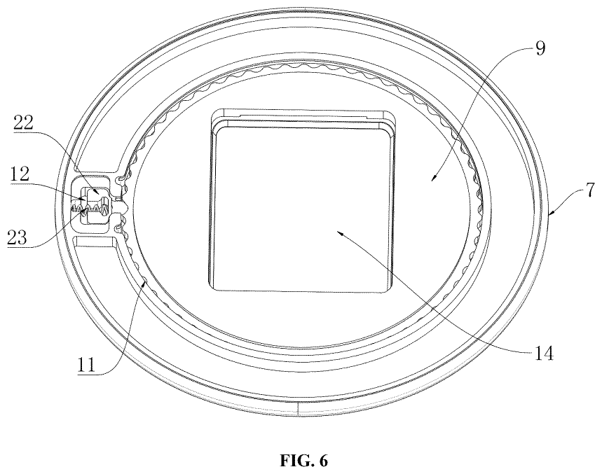

In a specific embodiment of the present disclosure, as shown in FIG. 4 and FIG. 5, the connecting disk component 1 includes an outer ring seat 7, a connecting portion 5, and a base plate 8. The outer ring seat 7 is an annular structure, and may be a circular annular structure. In this way, a middle part of the outer ring seat 7 and the base plate 8 form the mounting groove 6. One end that is of the outer ring seat 7 and that faces the base plate 8 is provided with a setting groove. The connecting portion 5 is disposed in the setting groove. The outer ring seat 7 is connected to the base plate 8. By setting this type of annular outer ring seat 7, the space of the mounting groove 6 at the middle part is as large as possible, and the rotational connecting component 2, the hinge rod portion 3, and the supporting disk portion 4 are accommodated, so that the folding effect is as good as possible.

Specifically, the setting groove is located on a peripheral side of the mounting groove 6, and the connecting portion 5 is a magnet. The mounting groove 6 is disposed in a peripheral direction of the magnet. In this way, a connection area between the magnet and the mobile phone is large enough, to ensure that a connection effect is as good as possible.

The connecting portion 5 may alternatively be another connecting structure, such as an adhesive layer. When the adhesive layer is used, the adhesive layer needs to be disposed on the base plate 8, so that the adhesive layer is directly adhered and connected to the mobile phone.

In some embodiments, as shown in FIG. 4 and FIG. 5, the rotational connecting component 2 includes a gear rotating disk 9 and an elastic limiting component 10. One end that is of the outer ring seat 7 and that faces the base plate 8 is provided with an annular groove 11 and a limiting groove 12. Specifically, the annular groove 11 is located on a peripheral side of the mounting groove 6. The limiting groove 12 is located on one side that is of the annular groove 11 and that is away from the mounting groove 6. The limiting groove 12 is in communication with the annular groove 11. The gear rotating disk 9 is disposed in the annular groove 11. That is, it is ensured that the peripheral side of the gear rotating disk 9 may be located in the annular groove 11, so as to play a role in limiting the gear rotating disk 9 from the connecting disk component 1. The elastic limiting component 10 is disposed in the limiting groove 12. One end of the elastic limiting component 10 abuts against an inner wall of the limiting groove 12, and the other end of the elastic limiting component 10 abuts against an outer peripheral gear surface of the gear rotating disk 9. An abutting manner of the elastic limiting component 10 and the outer peripheral gear surface of the gear rotating disk 9 may play a role in limiting the gear rotating disk 9, so that angle adjustment can be performed based on demands. When manual adjustment is not needed, a limiting role of the elastic limiting component 10 and the gear rotating disk 9 can limit rotation of the gear rotating disk 9.

It should be noted that the elastic function of the elastic limiting component 10 may enable one end of the elastic limiting component 10 to abut against the outer peripheral gear surface of the gear rotating disk 9, thereby achieving a limitation effect. When a pressure applied by means of manual adjustment is relatively large, an elastic member of the elastic limiting component 10 is compressed, so that the elastic limiting component 10 can be rotated and adjusted.

In a specific embodiment of the present disclosure, the elastic limiting component 10 may include a limiting member 22 and a resetting member 23. As shown in FIG. 6, one end of the limiting member 22 abuts against an outer peripheral gear surface of the gear rotating disk 9, and the other end of the limiting member 22 is connected to the limiting groove 12 by using the resetting member 23. Specifically, one end of the limiting member 22 is disposed as a convex tooth structure that can be meshed with the outer peripheral circumferential gear surface of the gear rotating disk 9, and a U-shaped groove is disposed on the other end of the limiting member 22. However, the resetting member 23 may be a spring. One end of the spring abuts against the U-shaped groove, and the other end of the spring abuts against an inner wall of the limiting groove 12.

An inner width of the limiting groove 12 is greater than a width of a transition port that is in communication with the annular groove 11. A width of the limiting member 22 is relatively wide, and a convex tooth structure thereon is relatively narrow. A groove body that accommodates the spring is further disposed on a groove wall of the limiting groove 12 that is opposite to the transition port. In this way, a limitation effect on the spring can be achieved, so as to avoid the spring from shaking.

In some embodiments, the elastic limiting component 10 may alternatively be a spring needle.

Specifically, the elastic limiting component 10 may further include an open spring plate 18. Therefore, a spring plate groove may be disposed on an inner peripheral wall of the mounting groove 6. The open spring plate 18 is disposed in the spring plate groove. The gear rotating disk 9 is limited by using the open spring plate 18 and the annular groove 11. The elastic limiting component 10 may further include an elastic limiting component cover plate 19. The limiting groove 12 is covered with the elastic limiting component cover plate 19. The elastic limiting component 10 is limited in the limiting groove 12.

In some embodiments, as shown in FIG. 4 and FIG. 5, a middle part of the gear rotating disk 9 is provided with a first mounting hole 13. A first end of the hinge rod portion 3 is hinged to an inner wall of the first mounting hole 13, and the other end of the hinge rod portion 3 is hinged to the supporting disk portion 4. When the mobile phone stand is in a folded state, the hinge rod portion 3 can be folded into the first mounting hole 13. In this way, the volume of the mobile phone stand can be further reduced, so that the mobile phone stand is more convenient to carry.

In some embodiments, as shown in FIG. 4 and FIG. 5, the supporting disk portion 4 includes a disk housing 14 and a connecting plate 15. One end that is of the disk housing 14 and that faces the connecting disk component 1 is provided with an accommodation tank. The connecting plate 15 is disposed in the accommodation tank. A middle part of the connecting plate 15 is provided with a second mounting hole. The hinge rod portion 3 is hinged to an inner wall of the second mounting hole. The supporting disk portion 4 may further include a cover sheet 20 and a decorative sheet 21. The connecting plate 15 is covered with the cover sheet 20. The decorative sheet 21 is disposed at one end that is of the disk housing 14 and that is away from the connecting plate 15. The mobile phone stand may be decorated by using the decorative sheet 21, so that the mobile phone stand is more attractive in appearance.

In some embodiments, one end that is of the disk housing 14 and that is away from a hinge position of the hinge rod portion 3 and the supporting disk portion 4 is provided with a supporting protrusion 16, and the supporting protrusion 16 is planar. The supporting protrusion 16 is configured to make contact with a desktop or the like, and a planar shape has a better supporting effect. In addition, by setting the supporting protrusion 16, it is easier for the user to remove the supporting disk portion 4 from the mounting groove 6, so that the mobile phone stand is more convenient to use.

In some embodiments, an outer sleeve 17 is disposed outside the hinge rod portion 3, and the outer sleeve 17 is made of a skin-friendly material. Specifically, materials such as silicone rubber or rubber may be used.

In the present disclosure, the description of the terms such as “one embodiment”, “some embodiments”, “examples”, “specific examples” or “some examples” indicates to be contained in at least one embodiment or example of the disclosure in combination with specific characteristics, structures, materials or characteristics described by the embodiment or example. In the specification, schematic expression of the above terms does not necessarily refer to the same embodiment or example. Moreover, the described specific features, structures, materials or characteristics can be combined in any one or more embodiments or examples appropriately. In addition, those skilled in the art can integrate and combine different embodiments or examples and features of different embodiments or examples described in this specification without contradicting each other.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A mobile phone stand, comprising a connecting disk component, a rotational connecting component, a hinge rod portion, and a supporting disk portion, wherein a connecting portion configured to connect a mobile phone is disposed on the connecting disk component, one end of the connecting disk component is provided with a mounting groove, the rotational connecting component is rotatably disposed in the mounting groove, one end of the hinge rod portion is hinged to the rotational connecting component, and the other end of the hinge rod portion is hinged to the supporting disk portion; the supporting disk portion is able to be folded and be close to the connecting disk component, and the supporting disk portion is at least partially located in the mounting groove;
the connecting disk component comprises an outer ring seat, a connecting portion, and a base plate, a middle part of the outer ring seat and the base plate form the mounting groove, one end that is of the outer ring seat and that faces the base plate is provided with a setting groove, the connecting portion is disposed in the setting groove, and the outer ring seat is connected to the base plate; and
the rotational connecting component comprises a gear rotating disk and an elastic limiting component, one end that is of the outer ring seat and that faces the base plate is provided with an annular groove and a limiting groove, the annular groove is located on a peripheral side of the mounting groove, the limiting groove is located on one side that is of the annular groove and that is away from the mounting groove, the limiting groove is in communication with the annular groove, the gear rotating disk is disposed in the annular groove, the elastic limiting component is disposed in the limiting groove, one end of the elastic limiting component abuts against an inner wall of the limiting groove, and the other end of the elastic limiting component abuts against an outer peripheral gear surface of the gear rotating disk.

2. The mobile phone stand according to claim 1, wherein the setting groove is located on a peripheral side of the mounting groove, and the connecting portion is a magnet.

3. The mobile phone stand according to claim 1, wherein a middle part of the gear rotating disk is provided with a first mounting hole, a first end of the hinge rod portion is hinged to an inner wall of the first mounting hole, the other end of the hinge rod portion is hinged to the supporting disk portion, and the hinge rod portion is able to be folded into the first mounting hole.

4. The mobile phone stand according to claim 1, wherein the supporting disk portion comprises a disk housing and a connecting plate, one end that is of the disk housing and that faces the connecting disk component is provided with an accommodation tank, the connecting plate is disposed in the accommodation tank, a middle part of the connecting plate is provided with a second mounting hole, and the hinge rod portion is hinged to an inner wall of the second mounting hole.

5. The mobile phone stand according to claim 4, wherein one end that is of the disk housing and that is away from a hinge position of the hinge rod portion and the supporting disk portion is provided with a supporting protrusion, and the supporting protrusion is planar.

6. The mobile phone stand according to claim 1, wherein an outer sleeve is disposed outside the hinge rod portion, and the outer sleeve is made of a skin-friendly material.

7. The mobile phone stand according to claim 1, wherein the elastic limiting component comprises a limiting member and a resetting member, one end of the limiting member abuts against an outer peripheral gear surface of the gear rotating disk, and the other end of the limiting member is connected to the limiting groove by using the resetting member.

8. The mobile phone stand according to claim 1, wherein the elastic limiting component is a spring needle.
